(19) United States
(12) Patent Application Publication
(10) Pub. No.: US 2006/0179699 A1
(43) Pub. Date: Aug. 17, 2006

(54) Apparatus and method for displaying information

(76) Inventor: John Edmund Gemmell, CHEAM, SUTTON, SURREY (GB)

Correspondence Address: LOUIS VENTRE, JR, 2483 OAKTON HILLS DRIVE, OAKTON, VA, 22124-1530, US

(21) Appl. No.: 10/546,970

(22) PCT Filed: Feb. 28, 2003
(86) PCT No.: PCT/EP03/02089

§ 371 Date: Aug. 26, 2005

(51) Int. Cl. G09F 3/18

(52) U.S. Cl. 40/661

(57) ABSTRACT

The present invention relates to a display apparatus (1), the display item for which can be easily refreshed by a non-specialist. It further relates to a device for displaying information to one or more customers in a hair salon. It further relates to a method for presenting information to one or more customers in a hair salon.

### FIELD OF THE INVENTION

The present invention relates to a display apparatus, the display item for which can be easily refreshed by a non-specialist. It further relates to a device for displaying information to one or more customers in a hair salon. It further relates to a method for presenting information to one or more customers in a hair salon.

### BACKGROUND TO THE INVENTION

Wall mounted displaying apparatus, such as traditional picture frames comprising a frame holding a glass front, a rigid backing and a means of reversibly attaching the rigid backing to the frame are designed such that changing the display item is inconvenient; the frame needs to be removed from the wall, opened and once the new display item is inserted, the frame has to be reassembled and repositioned correctly on the wall. Thus, a large number of steps are required to change the display item. Where there is a plurality of displaying apparatuses and of display items, the process of changing the display item becomes time consuming. Where the display item requires frequent updating, the amount of time consumed can be excessive.

Due to the complexity of some displaying apparatuses, the process of changing the display item requires the services of a trained specialist; where there is plurality of displaying apparatuses and/or display items and/or frequent updating, the cost to the owner of the displaying apparatuses can be very high.

There is a need for a surface mounted displaying apparatus wherein the display item can be easily changed without the need for a trained specialist.

The effective displaying of information is limited by the amount of attention an individual gives to the display. This is in turn limited by the positioning of the display. For example, information notices, advertising displays, warning notices are often displayed in public places and require an individual not only to be in the vicinity of said display, but also to orient his head towards the display. Thus, the content of such displays are required to be eye catching and to contain a minimum of detail so that the information can be quickly absorbed at a distance. Alternatively, information might be displayed in areas where an individual is forced to spend time, such as in a bus shelter, in a waiting area. However, effective viewing of said information requires the individual to orient his eyes towards the display. The individual may choose not to read the information and may avert his gaze away from the information. There is a need for a method for displaying information wherein an individual may absorb said information with a reduced distraction there-from. There is a need for a method for displaying information wherein there is no requirement by the individual to substantially reorient his head or eyes towards said information

Collecting details from individuals and using said details to provide bespoke information, such as, for example, advertising material, educational material and entertainment material is difficult because an individual does not have time to disclose said details using traditional methods. Details include, but are not limited to information about lifestyle, education, professional and personal details, and personal preferences and attitudes. Traditional methods include postal questionnaires, telephone interviews, face-to-face interviews and computerised questionnaires. Furthermore, individuals do not have sufficient time to review said bespoke information provided as a result of said personal details, frequently because individuals increasingly have busy lifestyles. Advertising arriving through the ordinary postal service is frequently discarded without reading; telephone advertising and personal face-to-face selling is inconvenient for an individual and also regarded as invasive, especially when conducted at the home of an individual; with computerised messaging such as phone-text and email, the volume of messages received often means an individual does not have the time to read all the messages. There is a need for a method for collecting details from a individual wherein an individual has time to make disclosures and a method for providing bespoke information to an individual wherein said information is based on said details, and wherein said individual has time to review said information.

Patent documents DE 3218416 A and EP 0 270 756 A disclose a mirror in a hair salon wherein a region of the mirror surface, lying outside of the observation range of the customer, may hold information and/or advertising which becomes visible when illuminated by a lighting device located behind the mirror. GB2362494 discloses a variation thereof, wherein the information is displayed using a TFT unit.

PCT patent application number WO 01/18315 A, and JP 2000139777 disclose a system comprising a urinal or toilet proximal to a video screen. The system allows the user thereof to be exposed to advertising or other information. PCT patent application number WO 00/02099 and are a variation thereof wherein a sensor changes the condition of the visual display.

### DETAILED DESCRIPTION OF THE INVENTION

Static Display Apparatus

The present invention relates to a display apparatus that can be conveniently installed and the display items can be conveniently changed without need to remove the displaying apparatus from the wall and/or to dissemble the displaying apparatus. Furthermore, the time taken to change the display item is significantly reduced compared with that of a traditional displaying apparatuses, such as a picture frame. Furthermore, a non-specialist can be employed to change the display item. Furthermore, the cost of production of the displaying apparatuses is low.

In one embodiment of the present invention, the displaying apparatus comprises two flat, rigid surfaces joined by a hinge; when the hinge is closed, the surfaces overlap each other. One surface may be larger in area than the other, or both surfaces may have the same surface area. The display item is inserted between both surfaces. At least one surface is transparent, allowing the content of the display item to be seen. The displaying apparatus is attached to another surface.

The hinge may be sprung, such that it naturally returns to the closed form. Alternatively, the hinge may not be sprung, and the closed form is maintained by way of an attachment between the first and second surfaces. In one embodiment of the invention the first and second surfaces and the hinge are formed as a continuous surface wherein the hinge is closed; in this embodiment, the hinge is naturally sprung by way of the tensile and elastic properties of the material of the surface. Materials of suitable properties for the invention may be tested using methods of the art. In one aspect of the invention, the hinge may be orientated in any direction with respect to the orientation of the display item. For example, it may be positioned below the display item. Alternatively, it may be positioned above the display item. Alternatively, it may be positioned towards the side of the display item. The position of the hinge may depend on the strength of the spring in the sprung hinge in holding the display item, and on the most convenient direction of opening and closing the hinge for the user.

In one aspect of the present invention, both surfaces may have the same shape and surface area. Alternatively, one surface may have a different shape and surface area to the other surface. The shape and surface area may be determined by the shape and surface area of the item to be displayed. The shape and surface area may further be determined by individual style. The overlap between the first and second surfaces may be exact. Alternatively, the overlap may not be exact. The degree of overlap is determined in part by the surface area required to hold the display item, the size and position of the hinge and the strength of the spring in the sprung hinge.

According to one aspect of the invention, the surface of the display apparatus through which the display item is viewed is the same size as, or up to 10%, 20%, 30%, 40%, 50%, 60%, 70%, 80%, 90%, or 100% larger than the area of the display item.

According to one aspect of the invention, more than 70%, 80%, 90%, or 100% of the surface of the display item to be viewed is in contact with the transparent rigid surface.

According to one aspect of the invention, the display apparatus may accommodate a display item of any size. According to another aspect of the invention, the display apparatus is of a shape and size suitable for accommodating A0, A1, A2, A3, A4, A5 or A6-sized display items. According to another aspect of the invention, the display apparatus is of a shape and size suitable for accommodating postcard-, business card-, or credit card-sized display items. According to another aspect of the invention, the display apparatus is of a bespoke size and shape, suitable for accommodating bespoke sized and shaped display items. According to another aspect of the invention, a display item may comprise a combination of two or more display items, adjacently connected; a non-limiting example of this aspect of the invention is a display item suitable for the display of an A4 sized display item connected to a display item suitable for the display of business cards.

In another embodiment of the present invention, the display apparatus is attached to a fixed surface. By fixed surface, as used throughout herein is meant any supporting structure. Examples include, but are not limited to, a structure supported by a wall and/or floor and/or ceiling, a structure supported by said structures, a mounting attached thereto, a mirror attached thereto. Other examples of fixed surfaces include, but are not limited to a wall, a floor and/or wall and/or ceiling supported frame, and ceiling- and/or floor- and/or wall-supported tensile wires, ceiling-supported wires. In one embodiment of the present, the attachment is by means of an adhesive. The adhesive may be applied to a surface of the displaying apparatus to be attached to the fixed surface, or to the fixed surface itself. Alternatively, the adhesive may be in the form of one or more adhesive pads. The displaying apparatus may be supplied with the adhesive pad(s) pre-attached to the surface of the displaying apparatus to be attached to the fixed surface. Alternatively, the adhesive pad(s) may be applied to the frame prior to attachment.

In another embodiment of the present invention, the displaying apparatuses may be attached to the fixed surface by means of one or more screws. The displaying apparatus may contain one or more sets of holes for this purpose. In one embodiment, the displaying apparatus comprises a countersunk hole, suitable for accommodating the head of a screw in the surface of the displaying apparatus to be in contact with the fixed surface; in a position on the other surface of the displaying apparatus, corresponding to that of the counter sunk hole when the hinge is closed, is a second hole of a diameter larger than that of the screw head. This arrangement allows the displaying apparatus to be attached to a fixed surface using one or more screws without the need for opening the hinge of the displaying apparatus during attachment. By countersink, herein, is means to enlarge the upper part of the hole so that the head of the screw can be sunk below the surface. The invention is not limited to screws, but may include any attachment device that is a means of attachment and comprises a ‘shaft’ that can pass through the countersunk hole on the surface of the displaying apparatus in contact with the fixed surface and a ‘head’ that can pass through the hole on the other surface of the display apparatus, and sink below the surface of the countersink, whilst not passing through the countersunk hole. Examples of other attachment devices include, but are not limited to bolts, rivets, nails, and pins. Thus a display apparatus of the invention may be attached to a wall without opening the hinge, so rendering the task of attachment simple, rapid and convenient.

In one embodiment of the present invention, the displaying apparatus is made from Perspex. Alternatively, the display apparatus is made from one or more other plastic materials. Alternatively, the displaying apparatus is made from a mixture of materials. The surface of the displaying apparatus through which the display item is viewed may be made from any transparent material, such as glass or Perspex, or other transparent plastic, at least in the area through which the display item is viewed. Other, non-transparent, materials may be used in the construction. In a preferred embodiment, the use of non-transparent materials is limited to areas which do not substantially restrict the viewing of the display item. According to one aspect of the invention, the hinge may be constructed from the same material as the surfaces and forms part of said surfaces; according to this aspect of the invention, when a tensile and elastic material is used, it confers a spring property to the hinge, forcing the hinge closed in its natural position. Alternatively, the hinge may be made of a different material and construction

In one embodiment of the present invention, is a displaying apparatus comprising a surface surrounded by a frame, wherein between one to three slots are provided along the edges of the frame for insertion of the display item.

In one aspect of the invention, the area framed by the frame is smaller in size than the display item, but not so as to substantially obscure the display item. The frame may be smaller than the width, the length or both, of the display item. In order to insert the display item, and hold said display in place, one or more grooves are formed on the frame surfaces adjacent to the display surface. Said groove(s) are formed such that they accommodate the size of the display item, and are in contact with one or more edges of the display item.

The shape and surface area of the frame and framed areas may be determined by the shape and surface area of the item to be displayed. The shape and surface area may further be determined by individual style.

The length of the slit is determined according to the size of the display item. The length of the slit should be the same as or larger than the smallest edge of the display item. In one aspect of the invention, the length of the slit is such that it allows insertion of the display item, so that said display item is displayed in correct proportions to the shape of the displaying apparatus. For example, in a one embodiment, a landscape orientated display item is inserted into a landscape orientated displaying apparatus such that it is displayed in said displaying apparatus in the landscape orientation, and the size and position of the slit(s) facilitate said insertion.

According to one aspect of the invention, the display apparatus further comprises a transparent surface positioned such that the display item is viewed through said surface and such that it does not obstruct insertion of display item into said display apparatus. According to an aspect of the invention, the transparent display surface is attached to the frame.

According to one aspect of the invention, the surface of the display apparatus on which the display item is held is up to 10%, 20%, 30%, 40%, 50%, 60%, 70%, 80%, 90%, or 100% larger than the areas of the display item.

According to one aspect of the invention, the display apparatus may accommodate a display item of any size. According to another aspect of the invention, the display apparatus is of a shape and size to accommodate A0, A1, A2, A3, A4, A5 or A6-sized display items. According to another aspect of the invention, the display apparatus is of a shape and size to accommodate postcard-, business card-, or credit card-sized display items. According to another aspect of the invention, the display apparatus is of a bespoke size and shape, to accommodate bespoke sized and shaped display items.

In another embodiment of the present invention, the displaying apparatus is attached to a fixed surface. In one embodiment of the present invention, the attachment is by means of an adhesive. The adhesive may be applied to a surface of the displaying apparatus to be attached to the fixed surface, or to the fixed surface itself. Alternatively, the adhesive may be in the form of an adhesive pad. The displaying apparatus may be supplied with the adhesive pad pre-attached to the surface of the frame to be attached to the fixed surface. Alternatively, the adhesive pad may be applied to the frame in the prior to attachment.

In another embodiment of the present invention, the displaying apparatus may be attached to the fixed surface by means of one or more attachment devices such as screws, bolts, nails, pins, rivets. The displaying apparatus may contain one or more sets of holes for this purpose. In one embodiment, the frame comprises a countersunk hole, suitable for accommodating a countersunk attachment device in the surface of the displaying apparatuses to be in contact with the fixed surface.

In one embodiment of the present invention, the displaying apparatus is made from Perspex or other plastic type material. Alternatively, the displaying apparatus is made from a mixture of materials. The surface of the displaying apparatus through which the display item is viewed may be made from any transparent material, such as glass or Perspex, at least in the area through which the display item is viewed. Other, non-transparent, materials may be used in the construction. In a preferred embodiment, the use of non-transparent materials is limited to areas which do not substantially restrict the viewing of the display item. According to one aspect of the invention, said non-transparent materials include, but are not limited to metal, wood, plastic, aluminium, MDF, hardboard and wood chip.

Mirror, Display Apparatus and Chair

One aspect of the present invention is related to the finding that a customer having their hair styled in a hair salon, gazes primarily in one direction. It relates to the finding that information, presented in the field of vision of said customer during the styling of their hair, may be reviewed several times by the customer. It relates to the finding that a customer, during the styling of their hair in a hair salon readily absorbs visual information. It relates to the finding that said information may be primarily graphical, alphanumeric, or a mixture of both. Compared with the usual methods of displaying information, the invention is advantageous wherever the information is presented in the customer's field of vision. The inventors have further found that information presented towards the sides of a customer's field of vision is viewed and absorbed most effectively, information presented towards the lower half of a customer's field of vision is viewed and absorbed less effectively and information presented towards the upper half of a customer's field of vision is viewed and absorbed the least effectively.

By hair salon herein is meant any place that styles hair, and includes, but is not limited to, a barber's shop, a hairdressing salon, a hair stylist, a hairdressing school, a beauty clinic, a health centre, a coiffure, a private salon.

By styled or styling, means, for the purposes of this patent application, one or more acts normally performed by a hairdresser in relation to hair, including, but not limited to, dressing, modelling, cutting, colouring, perming, tinting, setting, bleaching, shaving, washing, highlighting, spraying, massaging the scalp, applying gel, platting, setting or fitting a wig, adding hair extensions.

By ‘within a field of vision’, in reference to a display item, for example, means viewable without substantial obstruction. It further means held at a distance such that substantially all the content is viewable. It further means held at a distance of less than 4 m, 3.5 m, 3 m, 2.5 m, 2 m, 1.5, 1 m from the individual. Alternatively, it means held at a distance of less than 4 m, 3.5 m. 3 m, 2.5 m, 2 m, 1.5 m, 1 m, 0.5 m, 0.25 m, 0.1 m from the centre of the mirror. Alternatively, it means held in a position such that a customer is not required to substantially orient his head and/or eyes during a styling in order to view said information.

One aspect of the present invention is a system comprising a displaying apparatus attached to a surface such that it is in the field of vision of a customer having their hair styled.

One embodiment of the present invention is a system comprising a chair on which the customer sits, a mirror through which the customer may view themselves and the stylist may view the customer, and one or more displaying apparatuses positioned within the field of vision of the customer.

In one aspect of the invention, the chair may be any device suitable for sitting on, including, but not limited to a swivel chair, a non adjustable chair, an adjustable barber's chair, a wheelchair, a stool, a bench, a children's chair, a children's toy suitable for children to sit on.

According to one aspect of the invention, the chair is positioned such that the head of the customer is not less than 50 cm, 1 m, 1.5 m, 2 m, 2.5 m, 3 m, 3.5 m, or 4.0 m from the mirror.

A mirror according to the invention may be any mirror of the art, including, but not limited to a non-tinted mirror, non-distorting mirror, a tinted mirror, a one way mirror, an illuminated mirror. The mirror is preferably attached vertically to a fixed surface, said fixed surfaced as defined above; as such it may be supported by wires, by a floor supported frame, be part of a trolley, fixed to a wall, fixed to a swivel mounting, to name a few examples. According to one aspect of the invention, the display apparatus may be positioned on the mirror. Alternatively, it may be positioned above, below, and/or to the sides of the mirror. In cases where the display apparatus is not attached to said mirror, it may be attached to a fixed surface, said fixed surface being as defined above. Alternatively, the mirror may reflect the display item presented by the displaying apparatus such that it is within the field of vision of the customer; the display item may be situated in any position that enables the customer to view its reflection, for example, behind the customer. Alternatively, the mirror may allow the passage of light from behind the reflective surface, so permitting the display item presented by the displaying apparatus to be viewed through the mirror, the displaying apparatus being positioned behind the mirror. Alternatively, the display apparatus may be positioned and/or viewed in any combination of the aforementioned alternatives. One or more display apparatuses may be utilized according to an aspect of the invention.

The displaying apparatus may be the static display apparatus disclosed herein above. In one aspect of the invention, the displaying apparatus contains a means for holding one or more information-displays.

In another aspect of the invention, the displaying apparatus contain a means for displaying more than one display item. Examples of display apparatuses which can display more than one display item include, but are not limited to, devices which mechanically move a display item from the field of vision, and replace it with another; examples are known in the art and include, but are not limited to revolving advertising boards, slide projectors.

According to another aspect of the invention, an example of a display apparatus that can display one or more items comprises a triangular-prism-shaped mounting which is capable of revolving along the long axis surface, to which one or more other suitable display apparatus(es) are attached. The revolving triangular-prism-shaped mounting may be placed along one or both sides of the mirror and/or above and/or below the mirror. The revolving mounting may be attached to the mirror and/or attached to a fixed surface adjacent to the mirror. Each surface of the revolving triangular-prism-shaped mounting is capable of holding at least one suitable display apparatus. The mounting may rotate by any means known in the art, such as, but not limited to, manual rotation, mechanised rotation, automated rotation.

Display apparatuses suitable for attachment thereto include, but are not limited to, the static display apparatus(es) as disclosed herein. Such a triangular-prism-shaped mounting provides a means for presenting three times as many display items as a non-rotating mounting, so representing a considerable space saving:

According to another aspect of the invention, an example of a display apparatus that can display one or more items comprises a moving surface to which one or more suitable display apparatus(es) are attached. A mechanism translates the said suitable display apparatus(es), moving the said display items across the field of vision of the customer. At one end of the surface, the translation motion causes said display items to be removed from view, while at the opposite end, other display iterri(s) are brought back into view by means of the translation motion. According to one aspect of the invention, the movement of the apparatus may be up-down-up, left-right-left, for example, depending on how the apparatus is oriented. For example, the movement of the apparatus is an up-down-up motion when it is attached directly to, or via a fixed surface adjacent to one or both sides of the mirror; the movement of the apparatus is a left-right-left motion when it is attached directly to, or via a fixed surface adjacent to the top and/or bottom of the mirror. Display apparatuses suitable for attachment thereto include, but are not limited to, the static display apparatus(es) as disclosed herein.

Another example of a displaying apparatus is a system which is capable of displaying moving images such as, for example a television, a monitor, a film projector, of which several variations include, but are not limited to a cathode ray screen, a plasma screen, an LCD screen, an LED screen, an OLED screen, a back-projected television. The image or the projection thereof produced by a displaying apparatus capable of displaying moving images, is the display item as used herein.

According to an aspect of the invention, the display item of the displaying apparatus may be restricted to the field of vision of the customer. According to an aspect of the invention, the display item of the displaying apparatus may be restricted for viewing at an angle of less than 70, 60, 50, 40, 30, or 20 degrees perpendicular to its surface. The restriction of viewing angle may be achieved according to known methods in the art. There may be one or plurality of displaying apparatuses within the field of vision of the customer.

According to one aspect of the invention, there may be one or a plurality of systems according to the invention in a hair salon. For example, a row of chairs in front of mirrors around and/or through which display items are situated, such that a one or a plurality of customers may view said display items when seated in said chairs.

According to one aspect of the invention, the plurality of displaying apparatuses are arranged across the upper and/or lower edges of the mirror, attached to the mirror and/or attached to a fixed surface adjacent to the mirror. According to an aspect of the invention the displaying apparatuses are arranged along one or both sides of the mirrors, attached to the mirror and/or attached to a fixed surface adjacent to the mirror. The displaying apparatuses may be at an angle of about 180 degrees to the mirror—i.e. more or less flat against the wall. Alternatively, the displaying surfaces may be at an angle of between 90 to 180 degrees to the mirror—i.e. oriented towards the direction of the customer. Where there is a plurality of mirrors and chairs, the displaying apparatuses may be attached to surfaces between the mirrors. Where there is a plurality of mirrors and the surfaces between the mirrors are at an angle of between 90 and 170 degrees to the surface of the mirrors, a triangular-prism-shaped mounting may be placed between pairs of mirrors to facilitate attachment of the displaying apparatuses at an angle of between 90 and 170 degrees. The display apparatus may be positioned in any combination of the aforementioned alternatives.

Method for Providing Information

Another aspect of the present invention is a method of providing information, wherein a customer having their hair styled in a hair salon, may view one or more display items presented by one or more display apparatuses.

This aspect of the invention is related to the finding that a customer having their hair styled in a hair salon, gazes primarily in one direction. It relates to the finding that information, presented in the field of vision of said customer during the styling of their hair, may be reviewed several times by the customer. It relates to the finding that a customer, during the styling of their hair in a hair salon readily absorbs information. It relates to the finding that said information may be primarily graphical, alphanumeric, or a mixture of both. Compared with the usual methods of displaying information, the invention is advantageous wherever the information is presented in the customer's field of vision. The inventors have further found that advertising presented towards the sides of a customer's field of vision is viewed and absorbed most effectively, information presented towards the lower half of a customer's field of vision is viewed and absorbed less effectively and advertising presented towards the upper half of a customer's field of vision is viewed and absorbed the least effectively. Furthermore, the inventors have found that within the time taken to perform an average hairstyle, the customer may absorb a plurality of information, comprising alphanumeric and graphical images. Furthermore, the time spent in front of said information allows the customer to review high-text content information. Furthermore, the relaxed state of the customer and/or the length of time of the hairstyling procedure allows disclosures from the customers regarding preferences which may be used for providing a profile of said customer. Examples of the types of information include, but are not limited to, advertisements, information notices, educational notices, entertainment notices.

One embodiment of the present invention is a method of providing information wherein a customer having their hair styled in a hair salon, may view one or more display items presented by one or more display apparatuses, wherein the customer is situated in front of a mirror around and/or through which one or more display apparatuses are situated. The system of the chair, mirror and display apparatus according to this aspect of the invention is fully disclosed herein under “mirror, display apparatus and chair” and includes all embodiment thereof.

One embodiment of the present invention is a method of providing information as disclosed above wherein a person normally associated with the salon, refreshes the advertisements. For example, where the display apparatus is the static display apparatus disclosed herein, said responsible person would remove previous information, and replace it with new information. Thus, new information, such as, for example, advertising material may be conveniently and cheaply forwarded directly to one or more salons, and the said person effects the refreshment of advertising. Forwarding may be performed by methods known in the art, including, but not limited to, surface post, courier, registered mail, recorded delivery, forwarding, personal delivery, facsimile, and/or by other electronic communication means, such as for example, email, internet. In another example, where the information is to be displayed on a screen, such as a television screen and/or a computer screen, the responsible person would facilitate refreshment, by, for example, changing a video tape, DVD or video disc, or downloading one or more electronic communications of new advertising material, for example by email, across the internet. The person associated with the salon may be an employee of the salon, a proprietor, a stylist, a person employed to refresh the information, or an employee.

In another embodiment of the present invention, the refreshing of information does not require the intervention of a person associated with the salon. In this aspect of the invention, information is displayed using a display apparatus that is capable of displaying moving images and can be controlled remotely according to methods of the art, such as, for example, across the internet, across the Public Switched Telephone network (PSTN) and/or the Integrated Services Digital Network (ISDN) and/or using Digital Subscriber Line (DSL).

One embodiment of the present invention is a method of providing information as disclosed above wherein the information is targeted. According to one aspect, the targeting is based on demographic information. Said demographic information may be obtained from, for example, commercial sources, Governmental sources, research by third parties, research conducted by salons, by the patent owner or any licensee, disclosures made by salon customers. According to an aspect of the invention, the target is a group of salons in the same geographical location, a group of salons in the same demographical group, a salon, and/or a customer or a type of customer.

One embodiment of the present invention is a method of providing information as disclosed above wherein details of a customer are procured by the hair stylist from the customer during a styling. Details include, but are not limited to information about lifestyle, education, profession, personal details, family background, personal preferences and/or attitudes. In one aspect, details are processed to determine the information most appropriate for said customer to view during said or future styling. In one aspect, details are processed to determine a profile of said customer. In another aspect of the invention, said details used by one or more third parties. In another aspect of the invention, said details are used to determine a demographical profile of salon customers. In one aspect, details of one or more customers are processed to determine the information most appropriate for a salon attended by said customers. In one aspect, details are processed of one or more customers to determine the information most appropriate for one or more salons in the same geographical location, attended by said customers. In one aspect, details are processed of one or more customers to determine the information most appropriate for one or more salons having a similar customer profiles. Questions to pose to customers, suitable personal, educational, professional, lifestyle, preference and/or attitude disclosures which are suitable for the purposes of advertising and/or customer profiling and/or demographic profiling are known in the art. Means of procuring information is by any means of the art, including but not limited to, asking questions orally, receiving answers orally, providing one or more questionnaires, asking a customer to complete one or more questionnaires, receiving one or more questionnaires, engaging in conversation with a customer, noting characteristics of customer. Information may be procured using any medium known in the art, for example, orally, on paper, using an input device. Examples of input devices include, but are not limited to a keyboard, a press button selector, a touch screen, one or more pedals, any input device of the art.

One embodiment of the present invention is a method of providing information as disclosed above wherein information targeted for one customer is presented to said customer while sat in a chair according to the invention. In one aspect of the invention, information suitable for one customer is displayed using a display apparatus capable of displaying moving images. In another aspect of the invention, information suitable for one customer is displayed using the static display apparatus of the invention.

In another aspect of the invention, advertisements which may be viewed using a display apparatus capable of displaying a moving image are selected from a pool of advertisements held locally at the salon. In another aspect of the invention, these advertisements are stored and transmitted to one or more display apparatuses viewed by the customer, from a remote location according to methods of the art, such as, for example, across the internet, across the Public Switched Telephone network (PSTN) and/or the Integrated Services Digital Network (ISDN) and or using Digital Subscriber Line (DSL).

In another aspect of the invention, advertisements which may be viewed using a display apparatus capable of displaying a moving image, are moving image advertisements. Examples include, but are not limited to, typical filmic advertisements such as those as seen on television and in the cinema, advertisements generated and displayed using a computer.

In another aspect of the invention, advertisements which may be viewed using a display apparatus capable of displaying a moving image, are static image advertisements.

In another aspect of the invention, advertisements which may be viewed using a display apparatus capable of displaying a moving image are presented alongside filmic content, such as, for example, drama, films, fashion shows, soap, documentary, cartoon, comedy, music, news, and educational content.

In another embodiment of the present invention, the refreshing of information occurs at least once a year. When the display apparatus is the static display apparatus, refreshing means changing the display item. When the display apparatus is capable of displaying moving images, refreshing means changing a filmic or static presentation, or a set of filmic or static presentations. Refreshing may occur at least twice, three, four, five, six, seven, eight, nine, ten, eleven, twelve, thirteen, fourteen, fifteen, sixteen, seventeen, eighteen, nineteen or twenty, twenty one, twenty two, twenty three or twenty four times a year or once every two weeks. Alternatively, the refreshing may occur at least once a week. Alternatively, the refreshing may occur at least once a day. The frequency of advertisement refreshment may be determined by the average time between customer visits, such that a customer may view a different advertisement or set of advertisements at every visit. The refreshing of information may further occur prior to or the time at which a particular customer or set of customers is scheduled for a hair styling; the information so presented may be based on details procured by the stylist from said customer or set of customers.

According to one embodiment of the present invention, a providing party provides one or more salons with a display apparatus according to the invention. According to an aspect of the invention, the providing party and the salon may enter into an agreement. In an aspect of the invention, the providing party may agree to supply and/or fix one or more display apparatus according to the invention within a salon. According to an aspect of the invention, the salon may agree to maintain the display apparatus(es) such that the information displayed therein is not substantially obscured by dust, dirt or by objects. In an aspect of the invention, the providing party may agree to supply information suitable for display in said display apparatus according to the invention. According to an aspect of the invention, the salon may agree to refresh the information according to instructions from the providing party.

According to an aspect of the invention, the providing party may agree to pay the salon a fee according to a number of factors. The factors might include, but are not limited to, number of display apparatuses put on view, the size of display apparatuses, the number of customers visiting the salon, the demographic profile of the salon, the typical customer profile of the salon, the geographical location of the salon, the volume of customer details obtained by the salon, and/or the quality of customer details obtained by the salon. According to an aspect of the invention, the location of one or more display apparatus(es) within a salon is determined by the providing party. According to another aspect of the invention, the display apparatus includes a mirror. According to another aspect of the invention, the display apparatus includes one or more fixed surfaces. According to another aspect of the invention, the providing party may use one or more agents to liaise with said salons.

According to another aspect of the invention, the providing party may enter into one or more agreements with one or more providers of information and/or their agents, herein known as information providers. The information providers and the providing party may agree that information providers supply information for display in salons. Examples of information might include, but are not limited to, advertising, education information, entertainment information and/or notification information. In one aspect of the invention, the information provider pays the providing party a fee to display information in one or more salons. Said fee might be based on the number of display apparatuses put on view, the size of display apparatuses, the number customers visiting the salon or viewing the information, the demographic profile of the salon, the typical customer profile of the salon, the geographical location of the salon, the volume of customer details obtained by the salon, and/or the quality of customer details obtained by the salon, and on the position of said display apparatus(es) in relation to the customer's field of vision. According to another aspect of the invention, the providing party and the information provider agree to refresh information at an interval as described above. According to another aspect of the invention, the providing party and the information provider agree to refresh information at an interval determined according to the scale and/or budget of an information campaign.

### FIGURES

FIG. 1. A first example of a display apparatus of the invention.

FIGS. 2a and b. An example of a display apparatus of the invention attached to a fixed surface.

FIG. 3. An example of a display apparatus of the invention, and attachment to a fixed surface by means of an adhesive pad.

FIG. 4. An example of a display apparatus of the invention, and attachment to a fixed surface by means of preformed holes.

FIG. 5. A second example of a display apparatus of the invention.

FIG. 6. An arrangement of a mirror, display apparatus and chair system of the invention.

FIG. 7. A triangular prism shaped fixed surfaces of the invention.

FIG. 8. A fixed surface arrangement comprising two triangular prism shaped fixed surfaces and a lower connecting fixed surface.

### EXAMPLES

The Examples provided are intended to illustrate a limited number of specific embodiments of the invention. They are not intended in any way to limit the scope of the invention.

1. First Example of a Display Apparatus of the Invention

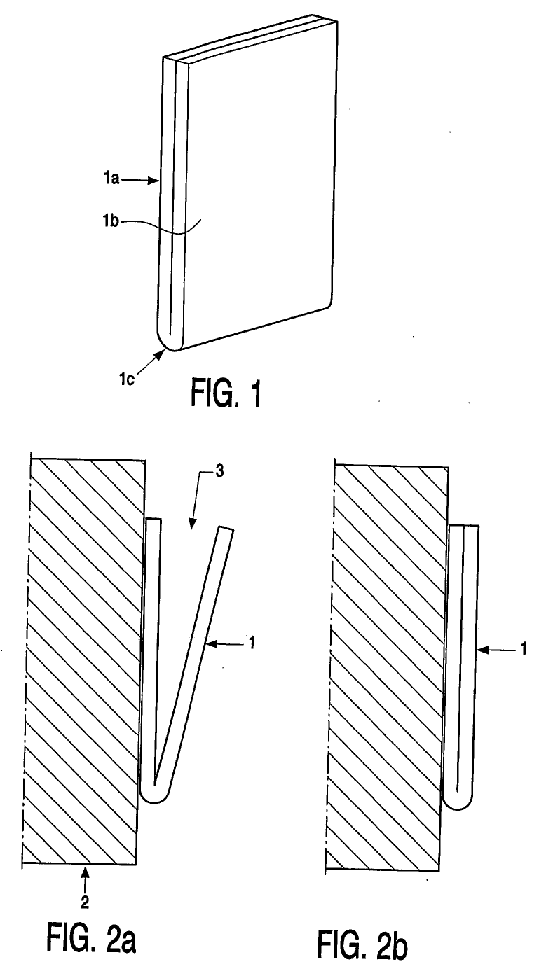

A display apparatus according to FIG. 1 is formed as a continuous surface and comprises two rigid, flat surfaces of equal shape and size [1a, 1b] joined by a hinge [1c]. The display apparatus according to FIG. 1 is formed from transparent Perspex, and the tensile and elastic properties of the material close the hinge [1c] in its natural position, such that surfaces [1a]and [1b] overlap.

The display apparatus [1] is attachable to a fixed surface [2], as indicated in FIG. 2a. Upon opening the hinge (FIG. 2a), a display item, such as for example, an A3 or A4 sized advertisement, may be inserted, such that upon closing the hinge (FIG. 2b), both surfaces are in contact with said display item [1].

2. Example of Means for Attachment to a Fixed Surface.

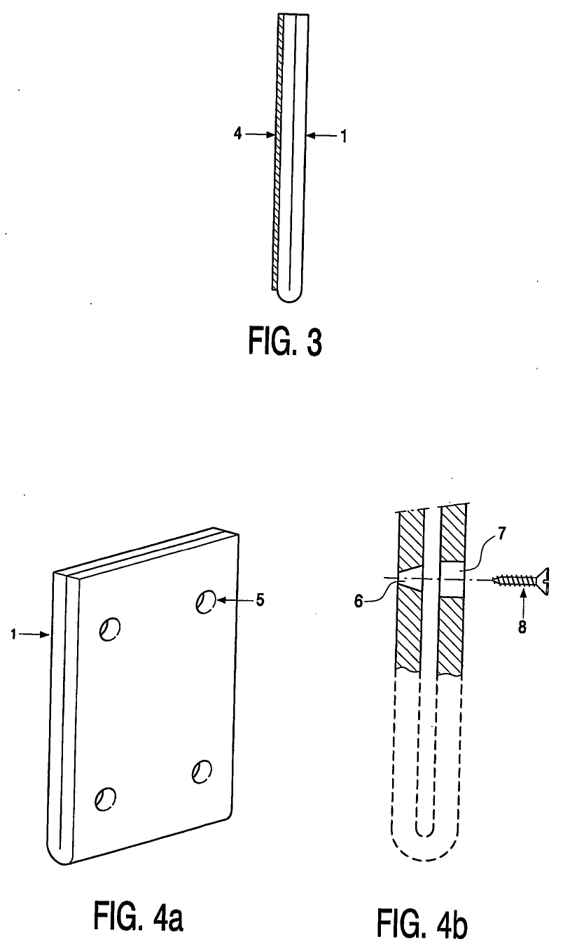

A display apparatus [1] such as that in FIG. 3 may be attached to a fixed surface by means of an adhesive pad [4] which is supplied prefixed, or may be attached prior to attachment in the salon to the surface of the display apparatus to be attached to the fixed surface.

FIG. 4a shows a display apparatus [1] comprising four holes [5] as means for attachment to a fixed surface. The surface of the display apparatus to be in contact with the fixed surface is prepared with a countersunk hole [6] as shown in the profile of the apparatus in FIG. 4b. The size of the hole and countersink are large enough to accommodate the shaft of a screw [8] and to place the head of the screw [8] substantially below the surface when placed through the hole [6]. The surface of the display item through which the display item is viewed is prepared with holes corresponding to the position of the countersunk holes in the closed position [7]. The diameter of each hole [7] is greater than the diameter of the screw head [8]. Thus, the display apparatus may be attached to the fixed surface without the need to open the hinge, and the screw head is below the surface of the display apparatus surface in contact with the fixed surface.

3. Second Example of a Display Apparatus According to the Invention

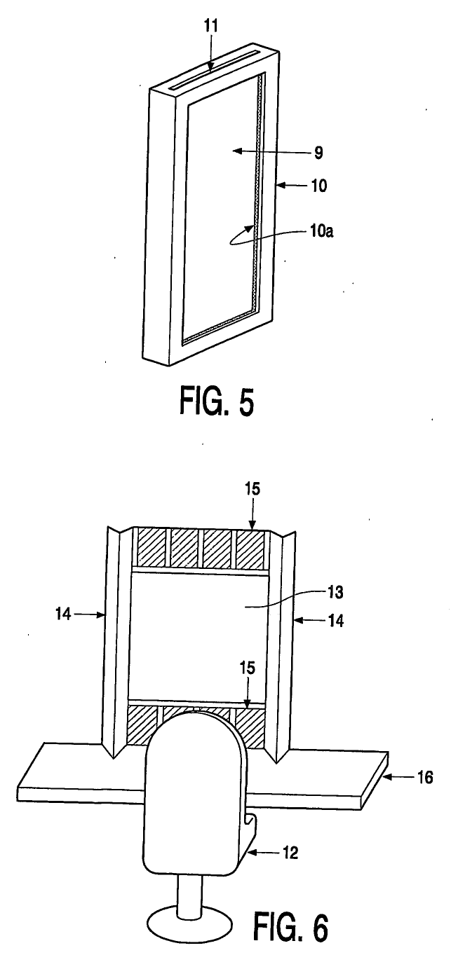

A display apparatus is illustrated in FIG. 5, and comprises a surface [9] surrounded by a frame [10], wherein one slot is provided along the top edge of the frame [11] for insertion of the display item. The display item is oriented such that the surface to be viewed is not in contact with the surface of the display item. The area framed by the frame [10] is smaller in size than the display item, but not so as to substantially obscure the display item. In order to insert the display item, and hold said display in place, one or more grooves [10a] are formed on the frame surfaces adjacent to the display surface. Said groove(s) are formed such that they sufficiently deep to accommodate the size of the display item, and are in contact with one or more edges of the display item.

4. Example of a Mirror, Display and Chair Apparatus

FIG. 6 illustrates an arrangement of a mirror, display apparatus and chair system of the invention. The apparatus comprises hair salon chair [12] on which the customer sits, a mirror [13] through which the customer may view themselves and the stylist may view the customer, and display apparatuses [15] located in the field of vision of the customer. The display apparatuses [15] are located above and below the mirror [13]. To the sides of the mirror are triangular prism shaped fixed surfaces [14] of sufficient size to attach one or more display items. The internal angles of the prism may not necessarily be equal, as indicated in the specification; the angle of the display item but may be chosen according to different factors, such as, for example, the space available, convenience of fixture, and/or the most suitable viewing angle. A counter typically found in hair salon is shown [16].

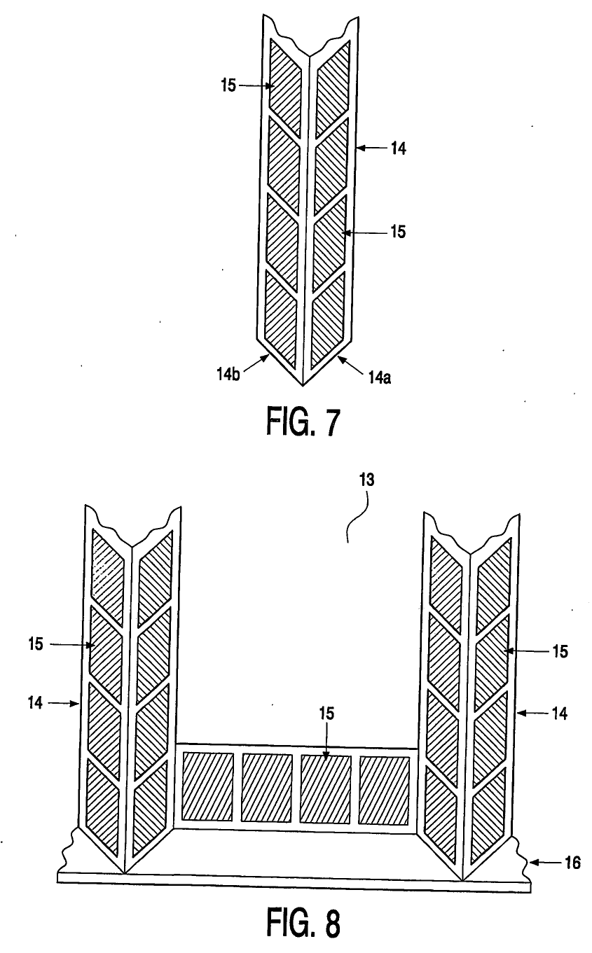

The said triangular prism shaped fixed surface [14] is also depicted in FIG. 7 as a separate component. One surface of the prism [14a] places the display apparatus [15] at an angle suitable for viewing by a customer seated directly to the right of said display apparatus. The other surface of the prism [14b] places the display apparatus [15] at an angle suitable for viewing by a customer seated directly to the left of said display apparatus.

A non-limiting example of a possible component to be installed in a salon is depicted in FIG. 8, comprising said triangular prism shaped fixed surface [14] and a fixed surface below the mirror. The component comprises a left hand and a right hand triangular prism shaped fixed surface [14] connected by a lower fixed surface. Display apparatuses [15] may be attached to said fixed surfaces. The component may be attached to a wall such that it surrounds the mirror of a salon [13] and rests on a counter [16]. Alternatively, the component may attach to the mirror. Not shown here is an optional upper fixed surface positioned above the mirror [13], which would connect both left hand and a right hand triangular prism shaped fixed surfaces, in the same way as the lower fixed surface.

1. A display apparatus suitable for presenting a display item, comprising two flat, rigid surfaces joined by one or more hinges, said surfaces overlapping each other when the hinge is in closed position, wherein the overlapping area of each surface forms a contact with said display item, wherein at least one surface is transparent, and said display apparatus is attachable to a fixed surface,

2. An apparatus according to claim 1 further comprising a means for attaching said apparatus to said fixed surface comprising:
a) one or more a countersunk holes suitable for accommodating the head of an attachment device in the rigid surface of the displaying apparatus in contact with the fixed surface;
b) in a position on the other rigid surface of the displaying apparatus, corresponding to that of the counter sunk hole when the hinge is closed, a second hole of a diameter larger than the size of the head of the attachment device.

3. An apparatus according to claims 1 and 2 wherein both surfaces and hinge are formed as a continuous surface, wherein the hinge is sprung closed.

4. An apparatus according to claim 3 wherein said continuous surface is formed from Perspex or any other plastic material.

5. A display apparatus suitable for presenting a display item comprising a surface surrounded by a frame, wherein between one and three slots are provided along the edges of said frame for insertion of the display item.

6. A device suitable for presenting information held in a display apparatus to a customer in a hair salon, comprising:
a chair on which a customer sits,
a mirror through which the customer may view themselves and the stylist may view the customer for the purpose of styling hair,
one or more display apparatuses, according to any of claims 1 to 5 attached to, said mirror and/or one or more fixed surfaces and/on or adjacent to said mirror such that said information is in the field of vision of the customer.

7. A method of providing information to a customer in a hair salon, comprising:
providing to a hair salon comprising a chair on which a customer sits, a mirror through which the customer may view themselves and the stylist may view the customer for the purpose of styling hair, one or more display apparatuses according to any of claims 1 to 5
attaching said apparatus to said mirror and/or one or more fixed surfaces on and/or adjacent to said mirror, such that information held therein is within the field of vision of said customer, and
viewing of said information by seated customer during said styling.

8. A method according to claim 7 further comprising:
procuring details from said customer during said styling, and
determining from said details, type of said information viewed by said customer during said styling and/or subsequent styling(s).

9. A method of providing information to a customer in a hair salon, comprising:
providing to a hair salon comprising a chair on which a customer sits, a mirror through which the customer may view themselves and the stylist may view the customer for the purpose of styling hair, one or more display apparatuses capable of displaying moving images,
attaching said apparatus to said mirror and/or one or more fixed surfaces on and/or adjacent to said mirror, such that information held therein is within the field of vision of said customer, and
procuring details from said customer during said styling,
determining from said details, type of said information to be viewed by said customer during current or subsequent styling(s), and
viewing of said information by seated customer during said styling and/or subsequent stylings.

10. A method according to any of claims 7 to 9 further comprising:
refreshing said information, said refreshing performed a person associated with said salon.

11. A method according to claim 10 wherein said refreshing is performed at an interval derived from the average interval between customer visits.

12. A method according to claim 10 wherein said refreshing is performed at a regular interval.

13. A method according to claims 7 to 12 further comprising:
providing, by a providing party, said display apparatus and information suitable therefor.

14. A method according to claims 7 to 13 further comprising:
providing, by a providing party, said display apparatus, mirror and information suitable therefor.

15. A method according to claims 13 and 14 further comprising:
determining, by said providing party, content of information to be displayed, based on said procured information.

16. A method according to any of claims 13 to 15 wherein said information is forwarded by the providing party to one or more salons by surface post, facsimile, and/or by other electronic communication means.

17. A method according to any of claims 13 to 16 further comprising:
providing party and salon agreeing to one or more contractual agreements.

18. A method according to claim 17 wherein said agreement comprises:
a) an agreement by said providing party to provide one or more of said display apparatuses and display items therefor.
b) an agreement by said salon to facilitate refreshment of display items.

19. A method according to any of claims 13 to 18 further comprising:
providing party and one or more information providers agreeing to displaying information in said salon.

20. A method according to claim 19 further comprising:
determining the cost to the providing party of displaying information in said salon, wherein said cost is determined by the position of said display apparatus in relation to field of vision of said customer.

21. A method according to any of claims 8 to 20 wherein said information is advertising.
